(19) United States
(12) Patent Application Publication
(10) Pub. No.: US 2025/0079053 A1
(43) Pub. Date: Mar. 6, 2025

(54) CHIP RESISTOR AND ELECTRONIC CIRCUIT DEVICE

(71) Applicant: ROHM CO., LTD., Kyoto (JP)

(72) Inventors: Daisuke KAMITANI, Kyoto (JP); Toshihiro KISHI, Kyoto (JP)

(21) Appl. No.: 18/798,255

(22) Filed: Aug. 8, 2024

(30) Foreign Application Priority Data
Aug. 28, 2023 (JP) 2023-137763

(51) Int. Cl. H01C 17/00; H01C 1/028; H01C 1/142; H01C 7/06; H01C 17/23

(52) U.S. Cl. CPC H01C 17/006; H01C 1/028; H01C 1/142; H01C 7/06; H01C 17/23

(57) ABSTRACT

A chip resistor includes: an insulating substrate having a front surface, a back surface on an opposite side of the insulating substrate from the front surface, a first end surface connected to the front surface and the back surface, and a second end surface on an opposite side of the insulating substrate from the first end surface; a resistor layer disposed over the front surface; a first electrode connected to the resistor layer; and a second electrode connected to the resistor layer, wherein the first end surface and the second end surface are spaced apart from each other in a direction in which the first electrode and the second electrode are spaced apart from each other, and wherein the first electrode includes a first back surface electrode disposed over the back surface and electrically connected to the resistor layer.

### CROSS-REFERENCE TO RELATED APPLICATION

This application is based upon and claims the benefit of priority from Japanese Patent Application No. 2023-137763, filed on Aug. 28, 2023, the entire contents of which are incorporated herein by reference.

### TECHNICAL FIELD

The present disclosure relates to a chip resistor and an electronic circuit device.

### BACKGROUND

In the related art, there is known a chip resistor.

### BRIEF DESCRIPTION OF DRAWINGS

The accompanying drawings, which are incorporated in and constitute a part of the specification, illustrate embodiments of the present disclosure.

FIG. 1 is a schematic plan view of a chip resistor according to an embodiment of the present disclosure.

FIG. 2 is a schematic cross-sectional view of the chip resistor according to the embodiment taken along line II-II in FIG. 1.

FIG. 3 is a schematic bottom view of the chip resistor according to the embodiment.

FIG. 4 is a schematic cross-sectional view of the chip resistor and an electronic circuit device according to the embodiment.

FIG. 5 is a schematic cross-sectional view of an electronic circuit device according to a modification of the embodiment.

FIG. 6 is a schematic cross-sectional view showing a step of a method of manufacturing a chip resistor according to an embodiment of the present disclosure.

FIG. 7 is a schematic cross-sectional view showing a step subsequent to the step shown in FIG. 6 in the method of manufacturing the chip resistor according to the embodiment.

FIG. 8 is a schematic cross-sectional view showing a step subsequent to the step shown in FIG. 7 in the method of manufacturing the chip resistor according to the embodiment.

FIG. 9 is a schematic cross-sectional view showing a step subsequent to the step shown in FIG. 8 in the method of manufacturing the chip resistor according to the embodiment.

FIG. 10 is a schematic cross-sectional view showing a step subsequent to the step shown in FIG. 9 in the method of manufacturing the chip resistor according to the embodiment.

FIG. 11 is a schematic cross-sectional view showing a step subsequent to the step shown in FIG. 10 in the method of manufacturing the chip resistor according to the embodiment.

FIG. 12 is a schematic cross-sectional view showing a step subsequent to the step shown in FIG. 11 in the method of manufacturing the chip resistor according to the embodiment.

FIG. 13 is a schematic cross-sectional view showing a step subsequent to the step shown in FIG. 12 in the method of manufacturing the chip resistor according to the embodiment.

FIG. 14 is a schematic cross-sectional view showing a step subsequent to the step shown in FIG. 13 in the method of manufacturing the chip resistor according to the embodiment.

FIG. 15 is a schematic cross-sectional view showing a step subsequent to the step shown in FIG. 14 in the method of manufacturing the chip resistor according to the embodiment.

FIG. 16 is a schematic cross-sectional view of a chip resistor and an electronic circuit device according to a comparative example.

FIG. 17 is a graph showing a relationship between a bonding strength between a chip resistor and a land pattern and an area of a back surface electrode.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

The details of the embodiments of the present disclosure will be described with reference to the drawings. In the drawings, the same or corresponding parts are designated by like reference numerals, and the description thereof will not be repeated. At least some of the configurations of the embodiments described below may be arbitrarily combined.

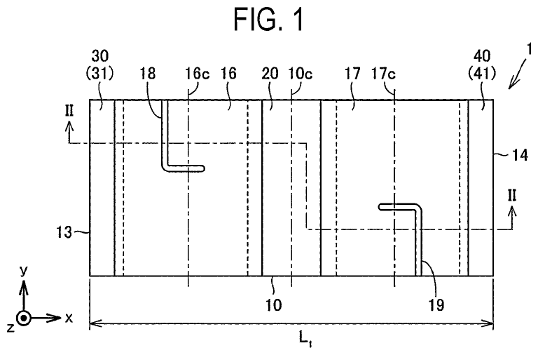

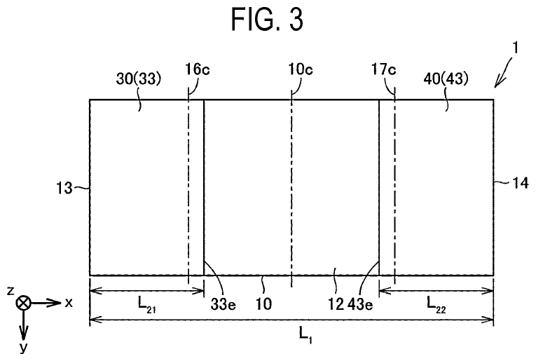

A chip resistor 1 according to an embodiment of the present disclosure will be described with reference to FIGS. 1 to 3. The chip resistor 1 mainly includes an insulating substrate 10, a resistor layer 15, a first electrode 30, and a second electrode 40. The chip resistor 1 may further include an intermediate electrode 20, a first insulating protective layer 25, and a second insulating protective layer 26. For the sake of convenience, in FIGS. 1 and 3, illustrations of a portion of the first electrode 30, a portion of the second electrode 40, the first insulating protective layer 25, and the second insulating protective layer 26 are omitted.

The insulating substrate 10 is made of an insulating material such as alumina (Al₂O₃) or the like. The insulating substrate 10 includes a front surface 11, a back surface 12 on an opposite side of the insulating substrate from the front surface 11, a first end surface 13, and a second end surface 14 on an opposite side of the insulating substrate from the first end surface 13.

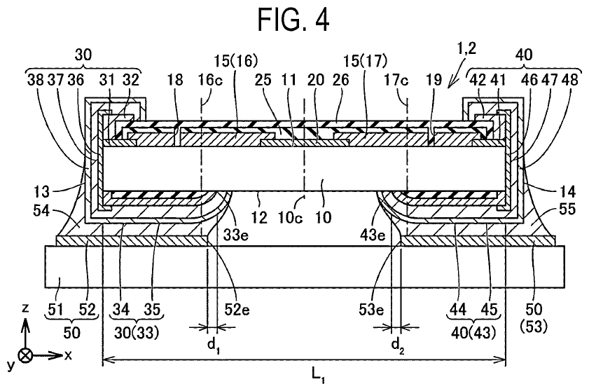

Each of the front surface 11 and the back surface 12 extends along a first direction (x direction) and a second direction (y direction) perpendicular to the first direction. The first direction (x direction) is a longitudinal direction of the insulating substrate 10. The second direction (y direction) is a lateral direction of the insulating substrate 10. The front surface 11 and the back surface 12 are spaced apart from each other in a third direction (z direction) perpendicular to the first direction (x direction) and the second direction (y direction). The third direction (z direction) is a thickness direction of the insulating substrate 10. The front surface 11 and the back surface 12 are both end surfaces of the insulating substrate 10 in the thickness direction. As shown in FIG. 4, when the chip resistor 1 is mounted on a circuit board 50, the back surface 12 faces the circuit board 50.

The first end surface 13 and the second end surface 14 are connected to the front surface 11 and the back surface 12, respectively. The first end surface 13 and the second end surface 14 extend along the second direction (y direction) and the third direction (z direction), respectively. The first end surface 13 and the second end surface 14 are, for example, both end surfaces in the longitudinal direction of the insulating substrate 10. The first end surface 13 and the second end surface 14 are spaced apart from each other in a direction in which the first electrode 30 and the second electrode 40 are spaced apart from each other (first direction (x direction)). A distance between the first end surface 13 and the second end surface 14 is, for example, a length L₁ of the insulating substrate 10 in the longitudinal direction (first direction (x direction)) of the insulating substrate 10. The length L₁ of the insulating substrate 10 is, for example, greater than 3.2 mm. The length L₁ may be 4.0 mm or more, or 6.0 mm or more.

The resistor layer 15 has, for example, a function of limiting a current or a function of detecting a current. The resistor layer 15 is disposed over the front surface 11 of the insulating substrate 10. The resistor layer 15 is made of a conductive material containing conductive particles, such as a ruthenium oxide (RuO₂) or a silver-palladium alloy, and glass.

The resistor layer 15 may include a first resistor layer portion 16 and a second resistor layer portion 17. The first resistor layer portion 16 and the second resistor layer portion 17 are spaced apart from each other in the direction (first direction (x direction)) in which the first electrode 30 and the second electrode 40 are spaced apart from each other. The first resistor layer portion 16 is provided near the first end surface 13 of the insulating substrate 10. The first resistor layer portion 16 is closer to the first end surface 13 than the second resistor layer portion 17. The second resistor layer portion 17 is provided near the second end surface 14 of the insulating substrate 10. The second resistor layer portion 17 is closer to the second end surface 14 than the first resistor layer portion 16. The first resistor layer portion 16 is connected to the first electrode 30 (a first front surface electrode 31 and a first auxiliary electrode 32) and the intermediate electrode 20. The second resistor layer portion 17 is connected to the second electrode 40 (a second front surface electrode 41 and a second auxiliary electrode 42) and the intermediate electrode 20.

Trimming grooves 18 and 19 may be formed in the resistor layer 15. By forming the trimming grooves 18 and 19 in the resistor layer 15, a resistance value of the chip resistor 1 can be accurately determined. Specifically, the trimming groove 18 is formed in the first resistor layer portion 16. The trimming groove 19 is formed in the second resistor layer portion 17. One of the trimming groove 18 and the trimming groove 19 may be omitted.

The intermediate electrode 20 is disposed over the front surface 11 of the insulating substrate 10. The intermediate electrode 20 is disposed between the first front surface electrode 31 and the second front surface electrode 41 in the direction in which the first electrode 30 and the second electrode 40 are spaced apart from each other (first direction (x direction)). The intermediate electrode 20 is connected to the first resistor layer portion 16 and the second resistor layer portion 17. The intermediate electrode 20 electrically connects the first resistor layer portion 16 and the second resistor layer portion 17 to each other in series. The intermediate electrode 20 is made of a conductive material containing, for example, metal particles (e.g., silver particles), and glass.

The first insulating protective layer 25 covers the resistor layer 15 and protects the resistor layer 15. The first insulating protective layer 25 may further cover the intermediate electrode 20 and may further protect the intermediate electrode 20. The first insulating protective layer 25 may further cover a part of the first front surface electrode 31 of the first electrode 30 and a part of the second front surface electrode 41 of the second electrode 40. The first insulating protective layer 25 is made of an insulating material such as glass, for example.

The second insulating protective layer 26 covers the first insulating protective layer 25. The second insulating protective layer 26 may further cover a part of the first front surface electrode 31 of the first electrode 30 and a part of the second front surface electrode 41 of the second electrode 40. The second insulating protective layer 26 may be filled in the trimming grooves 18 and 19 of the resistor layer 15. The second insulating protective layer 26 is made of an insulating resin such as an epoxy resin or the like.

The first electrode 30 is disposed near the first end surface 13 of the insulating substrate 10. The first electrode 30 is closer to the first end surface 13 than the second electrode 40. The first electrode 30 is connected to the resistor layer 15 (first resistor layer portion 16). The first electrode 30 includes a first front surface electrode 31, a first back surface electrode 33, and a first side surface electrode 36. The first electrode 30 may further include a first auxiliary electrode 32, a first inner plating film 37, and a first outer plating film 38.

The first front surface electrode 31 is disposed over the front surface 11 of the insulating substrate 10. The first front surface electrode 31 is disposed over a portion of the front surface 11 near the first end surface 13. The first front surface electrode 31 is disposed over a portion of the front surface 11 close to the first end surface 13. The first front surface electrode 31 is connected to the resistor layer 15 (first resistor layer portion 16). In a plan view of the front surface 11 of the insulating substrate 10, the first front surface electrode 31 has, for example, a rectangular shape. The first front surface electrode 31 is made of a conductive material containing, for example, metal particles (e.g., silver particles), and glass.

The first auxiliary electrode 32 is disposed over the first front surface electrode 31 and is connected to the first front surface electrode 31. The first auxiliary electrode 32 may be further disposed over the second insulating protective layer 26. The first auxiliary electrode 32 is made of a conductive material containing, for example, a binder resin (e.g., an epoxy resin) and metal particles (e.g., silver particles) distributed in the binder resin.

The first back surface electrode 33 is disposed over the back surface 12 of the insulating substrate 10. The first back surface electrode 33 is disposed over a portion of the back surface 12 near the first end surface 13. The first back surface electrode 33 is disposed over a portion of the back surface 12 close to the first end surface 13. The first back surface electrode 33 includes an end 33e close to the center 10c of the insulating substrate 10 in the direction in which the first electrode 30 and the second electrode 40 are spaced apart from each other (first direction (x direction)). In a plan view of the front surface 11 or the back surface 12, the first back surface electrode 33 overlaps with the trimming groove 18. In a plan view of the front surface 11 or the back surface 12, the first back surface electrode 33 overlaps with the center 16c of the first resistor layer portion 16 in the above-mentioned direction (first direction (x direction)). The first back surface electrode 33 includes a first insulating resin layer 34 and a first conductive layer 35. The first back surface electrode 33 may have a two-layer structure formed of a first insulating resin layer 34 and a first conductive layer 35.

The first insulating resin layer 34 is disposed over the back surface 12 of the insulating substrate 10. The first insulating resin layer 34 is made of an insulating resin such as an epoxy resin or the like. The first insulating resin layer 34 improves a bonding strength of the first back surface electrode 33 to the insulating substrate 10.

The first conductive layer 35 is disposed over the first insulating resin layer 34. The first conductive layer 35 covers at least a portion of the first insulating resin layer 34. The first conductive layer 35 may cover the entire first insulating resin layer 34. The first conductive layer 35 may also be disposed over the back surface 12 of the insulating substrate 10. The first conductive layer 35 is made of a conductive material containing, for example, a binder resin (e.g., epoxy resin) and metal particles (e.g., silver particles) distributed in the binder resin.

The first side surface electrode 36 is disposed over the first end surface 13, the first front surface electrode 31, and the first back surface electrode 33 (first conductive layer 35) of the insulating substrate 10. The first side surface electrode 36 connects the first front surface electrode 31 and the first back surface electrode 33 to each other. The first side surface electrode 36 may also be disposed over the first auxiliary electrode 32, and may connect the first auxiliary electrode 32 and the first back surface electrode 33 to each other. The first side surface electrode 36 is made of, for example, a Ni—Cr alloy. The first side surface electrode 36 is formed by a sputtering method.

The first inner plating film 37 is disposed over the first auxiliary electrode 32, the first side surface electrode 36, and the first back surface electrode 33 (first conductive layer 35). The first inner plating film 37 covers the first auxiliary electrode 32, the first side surface electrode 36, and the first back surface electrode 33 (first conductive layer 35). The first inner plating film 37 protects the first front surface electrode 31, the first auxiliary electrode 32, the first side surface electrode 36, and the first back surface electrode 33 from heat and impact. The first inner plating film 37 may also be disposed over the second insulating protective layer 26. The first inner plating film 37 is, for example, a nickel plating layer.

The first outer plating film 38 is disposed over the first inner plating film 37. The first outer plating film 38 covers the first inner plating film 37. The first outer plating film 38 may also be disposed over the second insulating protective layer 26. The first outer plating film 38 is made of a material to which a bonding member such as solder is more easily attached than the first inner plating film 37. The first outer plating film 38 is, for example, a tin plating layer. As shown in FIG. 4, when the chip resistor 1 is mounted on the circuit board 50, the first outer plating film 38 is bonded to a land pattern 52 of the circuit board 50 via a bonding member 54.

The second electrode 40 is disposed near the second end surface 14 of the insulating substrate 10. The second electrode 40 is closer to the second end surface 14 than the first electrode 30. The first electrode 30 and the second electrode 40 are spaced apart from each other in the direction in which the first end surface 13 and the second end surface 14 are spaced apart from each other (first direction (x direction)). The second electrode 40 is connected to the resistor layer 15 (second resistor layer portion 17). The second electrode 40 includes a second front surface electrode 41, a second back surface electrode 43, and a second side surface electrode 46. The second electrode 40 may further include a second auxiliary electrode 42, a second inner plating film 47, and a second outer plating film 48.

The second front surface electrode 41 is disposed over the front surface 11 of the insulating substrate 10. The second front surface electrode 41 is disposed over a portion of the front surface 11 near the second end surface 14. The second front surface electrode 41 is disposed over a portion of the front surface 11 close to the second end surface 14. The second front surface electrode 41 is connected to the resistor layer 15 (second resistor layer portion 17). In a plan view of the front surface 11 of the insulating substrate 10, the second front surface electrode 41 has, for example, a rectangular shape. The second front surface electrode 41 is made of a conductive material containing, for example, metal particles (e.g., silver particles), and glass.

The second auxiliary electrode 42 is disposed over the second front surface electrode 41 and is connected to the second front surface electrode 41. The second auxiliary electrode 42 may be further disposed over the second insulating protective layer 26. The second auxiliary electrode 42 is made of a conductive material containing, for example, a binder resin (e.g., epoxy resin) and metal particles (e.g., silver particles) distributed in the binder resin.

The second back surface electrode 43 is disposed over the back surface 12 of the insulating substrate 10. The second back surface electrode 43 is disposed over a portion of the back surface 12 near the second end surface 14. The second back surface electrode 43 is disposed over a portion of the back surface 12 close to the second end surface 14. The second back surface electrode 43 includes an end 43e close to the center 10c of the insulating substrate 10 in the direction in which the first electrode 30 and the second electrode 40 are spaced apart from each other (first direction (x direction)). In a plan view of the front surface 11 or the back surface 12, the second back surface electrode 43 overlaps with the trimming groove 19. In a plan view of the front surface 11 or the back surface 12, the second back surface electrode 43 overlaps with the center 17c of the second resistor layer portion 17 in the above-mentioned direction (first direction (x direction)). The second back surface electrode 43 includes a second insulating resin layer 44 and a second conductive layer 45. The second back surface electrode 43 may have a two-layer structure formed of a second insulating resin layer 44 and a second conductive layer 45.

The second insulating resin layer 44 is disposed over the back surface 12 of the insulating substrate 10. The second insulating resin layer 44 is made of an insulating resin such as an epoxy resin or the like. The second insulating resin layer 44 improves a bonding strength of the second back surface electrode 43 to the insulating substrate 10.

The second conductive layer 45 is disposed over the second insulating resin layer 44. The second conductive layer 45 covers at least a portion of the second insulating resin layer 44. The second conductive layer 45 may cover the entire second insulating resin layer 44. The second conductive layer 45 may also be disposed over the back surface 12 of the insulating substrate 10. The second conductive layer 45 is made of a conductive material containing, for example, a binder resin (e.g., epoxy resin) and metal particles (e.g., silver particles) distributed in the binder resin.

The second side surface electrode 46 is disposed over the second end surface 14, the second front surface electrode 41, and the second back surface electrode 43 (second conductive layer 45) of the insulating substrate 10. The second side surface electrode 46 connects the second front surface electrode 41 and the second back surface electrode 43 to each other. The second side surface electrode 46 may also be disposed over the second auxiliary electrode 42, and may connect the second auxiliary electrode 42 and the second back surface electrode 43 to each other. The second side surface electrode 46 is made of, for example, a Ni—Cr alloy. The second side surface electrode 46 is formed by a sputtering method.

The second inner plating film 47 is disposed over the second auxiliary electrode 42, the second side surface electrode 46, and the second back surface electrode 43 (second conductive layer 45). The second inner plating film 47 covers the second auxiliary electrode 42, the second side surface electrode 46, and the second back surface electrode 43 (second conductive layer 45). The second inner plating film 47 protects the second front surface electrode 41, the second auxiliary electrode 42, the second side surface electrode 46, and the second back surface electrode 43 from heat and impact. The second inner plating film 47 may also be disposed over the second insulating protective layer 26. The second inner plating film 47 is, for example, a nickel plating layer.

The second outer plating film 48 is disposed over the second inner plating film 47. The second outer plating film 48 covers the second inner plating film 47. The second outer plating film 48 may also be disposed over the second insulating protective layer 26. The second outer plating film 48 is made of a material to which a bonding member such as solder is more easily attached than the second inner plating film 47. The second outer plating film 48 is, for example, a tin plating layer. As shown in FIG. 4, when the chip resistor 1 is mounted on the circuit board 50, the second outer plating film 48 is bonded to a land pattern 53 of the circuit board 50 via a bonding member 55.

An area ratio of the back surface electrode to the back surface 12 of the insulating substrate 10 is 31% or more. In the present disclosure, the area ratio of the back surface electrode to the back surface 12 of the insulating substrate 10 means a ratio of a sum of a first area of the first back surface electrode 33 and a second area of the second back surface electrode 43 to an area of the back surface 12 of the insulating substrate 10. The area of the back surface 12 of the insulating substrate 10, the first area of the first back surface electrode 33, and the second area of the second back surface electrode 43 are all areas in a plan view of the back surface 12. The above-mentioned ratio may be 38% or more, or may be 44% or more. Each of a first length L₂₁ of the first back surface electrode 33 in the direction in which the first electrode 30 and the second electrode 40 are spaced apart from each other (first direction (x direction)) and a second length L₂₂ of the second back surface electrode 43 in the above-mentioned direction is 0.8 mm or more. Each of the first length L₂₁ and the second length L₂₂ may be 1.0 mm or more, or may be 1.2 mm or more.

An electronic circuit device 2 of the present embodiment will be described with reference to FIG. 4. The electronic circuit device 2 includes a chip resistor 1, a circuit board 50, a bonding member 54, and a bonding member 55.

The circuit board 50 includes an insulating circuit board 51, a land pattern 52, and a land pattern 53 spaced apart from the land pattern 52. The first back surface electrode 33 is bonded to the land pattern 52 by using a bonding member 54 such as solder or the like. The second back surface electrode 43 is bonded to the land pattern 53 by using a bonding member 55 such as solder or the like. The land pattern 52 includes an end 52e that is adjacent to the center 10c of the insulating substrate 10 and adjacent to the land pattern 53 in the direction in which the first electrode 30 and the second electrode 40 are spaced apart from each other (first direction (x direction)). The land pattern 53 includes an end 53e that is adjacent to the center 10c of the insulating substrate 10 and adjacent to the land pattern 52 in the above-mentioned direction (first direction (x direction)).

In the direction in which the first electrode 30 and the second electrode 40 are spaced apart from each other (first direction (x direction)), the end 33e of the first back surface electrode 33 is closer to the center 10c of the insulating substrate 10 than the end 52e of the land pattern 52. That is, in the above-mentioned direction, a distance d₁ between the end 33e of the first back surface electrode 33 and the end 52e of the land pattern 52 is greater than 0 mm. In the above-mentioned direction, the distance d₁ may be 0.2 mm or more, 0.4 mm or more, or 0.6 mm or more.

In the direction in which the first electrode 30 and the second electrode 40 are spaced apart from each other (first direction (x direction)), the end 43e of the second back surface electrode 43 is closer to the center 10c of the insulating substrate 10 than the end 53e of the land pattern 53. That is, in the above-mentioned direction, a distance d₂ between the end 43e of the second back surface electrode 43 and the end 53e of the land pattern 53 is greater than 0 mm. In the above-mentioned direction, the distance d₂ may be 0.2 mm or more, 0.4 mm or more, or 0.6 mm or more.

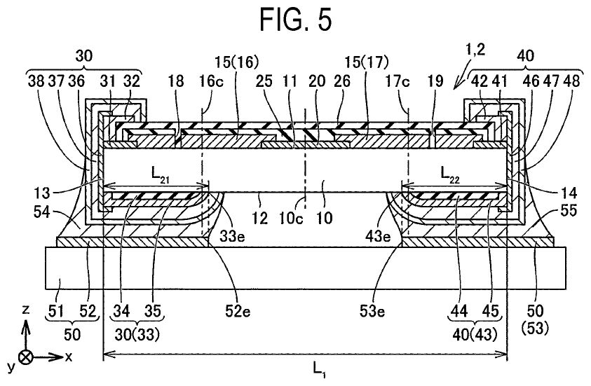

As shown in FIG. 5, in an electronic circuit device 2 of a modification of the present embodiment, the end 33e of the first back surface electrode 33 may be at the same position as the end 52e of the land pattern 52 in the direction in which the first electrode 30 and the second electrode 40 are spaced apart from each other (first direction (x direction)). That is, in the above-mentioned direction, the distance d₁ between the end 33e of the first back surface electrode 33 and the end 52e of the land pattern 52 may be 0 mm. In the direction in which the first electrode 30 and the second electrode 40 are spaced apart from each other (first direction (x direction)), the end 43e of the second back surface electrode 43 may be at the same position as the end 53e of the land pattern 53. That is, in the above-mentioned direction, the distance d₂ between the end 43e of the second back surface electrode 43 and the end 53e of the land pattern 53 may be 0 mm.

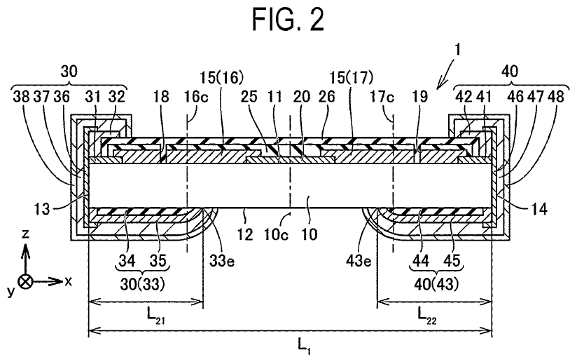

An example of a method of manufacturing the chip resistor 1 of the present embodiment will be described with reference to FIGS. 2 and 6 to 15.

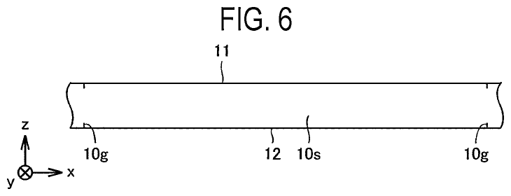

Referring to FIG. 6, a sheet substrate 10s is prepared. The sheet substrate 10s is made of an insulating material such as alumina or the like. The sheet substrate 10s includes a front surface 11 and a back surface 12 on an opposite side of the sheet substrate 10s from the front surface 11. A division groove 10g is formed on each of the front surface 11 and the back surface 12 of the sheet substrate 10s.

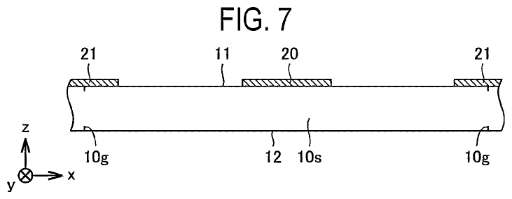

Referring to FIG. 7, a front surface conductive layer 21 and an intermediate electrode 20 are formed over the front surface 11 of the sheet substrate 10s. The front surface conductive layer 21 is formed over the front surface 11 of the sheet substrate 10s so as to straddle the division groove 10g of the sheet substrate 10s. The intermediate electrode 20 is formed between a pair of front surface conductive layers 21 adjacent to each other in the first direction (x direction). The front surface conductive layer 21 and the intermediate electrode 20 are formed, for example, by printing a paste containing metal particles (e.g., silver particles) and glass frit on the front surface 11 and baking the paste.

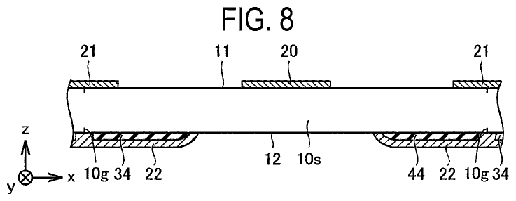

Referring to FIG. 8, a resin paste is printed on the back surface 12 of the insulating substrate 10 and cured to form a first insulating resin layer 34 and a second insulating resin layer 44 over the back surface 12 of the sheet substrate 10s. Then, a paste (e.g., silver paste) containing a binder resin (e.g., epoxy resin) and metal particles (e.g., silver particles) distributed in the binder resin is printed on the first insulating resin layer 34, the second insulating resin layer 44, and the back surface 12 of the insulating substrate 10 and cured to form a back surface conductive layer 22.

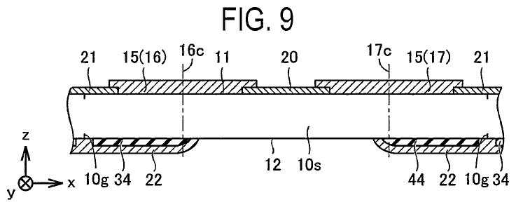

Referring to FIG. 9, a paste in which glass frit is contained in an electrical resistance material such as a ruthenium oxide (RuO₂) or a silver-palladium alloy is printed on the front surface 11 of the sheet substrate 10s and baked to form a resistor layer 15. The resistor layer 15 includes a first resistor layer portion 16 and a second resistor layer portion 17. The first resistor layer portion 16 is connected to the front surface conductive layer 21 and the intermediate electrode 20. The second resistor layer portion 17 is connected to the front surface conductive layer 21 and the intermediate electrode 20.

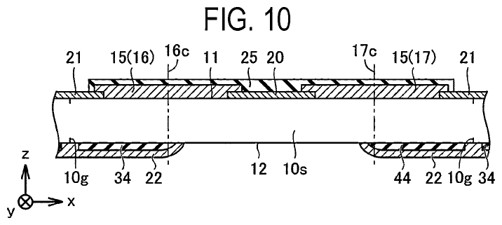

Referring to FIG. 10, for example, a paste containing glass is printed on the resistor layer 15, the intermediate electrode 20 and the front surface conductive layer 21 and backed to form a first insulating protective layer 25.

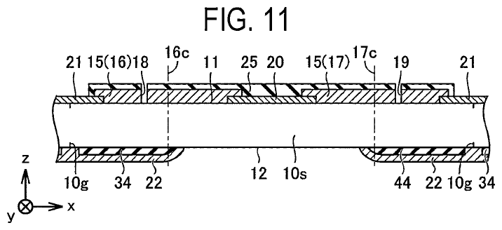

Referring to FIG. 11, trimming grooves 18 and 19 are formed in the resistor layer 15. The trimming grooves 18 and 19 are also formed in the first insulating protective layer 25. The trimming grooves 18 and 19 are formed, for example, by irradiating the resistor layer 15 and the first insulating protective layer 25 with laser light. When a resistance value of the resistor layer 15 becomes a target resistance value of the chip resistor 1, the formation of the trimming grooves 18 and 19 is completed. The first insulating protective layer 25 relieves thermal shock acting on the resistor layer 15 when the trimming grooves 18 and 19 are formed, and prevents the resistance value of the resistor layer 15 from fluctuating due to adhesion of fine particles generated during the formation of the trimming grooves 18 and 19 to the resistor layer 15.

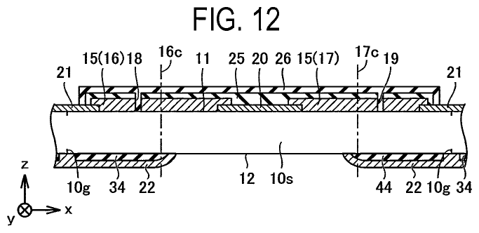

Referring to FIG. 12, for example, a paste containing an epoxy resin is printed on the first insulating protective layer 25 and the front surface conductive layer 21 and baked to form a second insulating protective layer 26. The second insulating protective layer 26 may be filled in the trimming grooves 18 and 19.

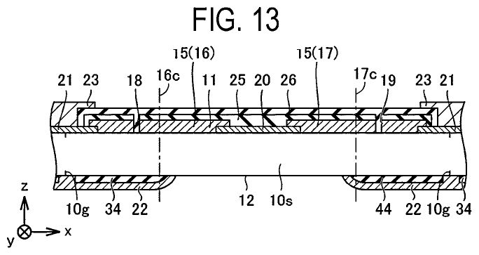

Referring to FIG. 13, an auxiliary electrode layer 23 is formed over the front surface conductive layer 21. The auxiliary electrode layer 23 may also be formed over the second insulating protective layer 26. For example, the auxiliary electrode layer 23 is formed by applying a paste (e.g., silver paste) containing a binder resin (e.g., epoxy resin) and metal particles (e.g., silver particles) distributed in the binder resin onto the front surface conductive layer 21 and the second insulating protective layer 26 and then curing the paste.

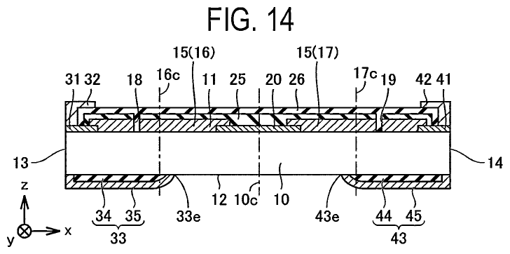

Referring to FIG. 14, the sheet substrate 10s is split along a plurality of division grooves 10g. The sheet substrate 10s is split into a plurality of insulating substrates 10. By splitting the sheet substrate 10s, a first end surface 13 and a second end surface 14 are formed. By splitting the sheet substrate 10s, the front surface conductive layer 21 is split into a first front surface electrode 31 and a second front surface electrode 41. By splitting the sheet substrate 10s, the auxiliary electrode layer 23 is split into a first auxiliary electrode 32 and a second auxiliary electrode 42, whereby the first auxiliary electrode 32 and the second auxiliary electrode 42 are formed. By splitting the sheet substrate 10s, the back surface conductive layer 22 is split into a first conductive layer 35 and a second conductive layer 45, whereby a first back surface electrode 33 and a second back surface electrode 43 are formed.

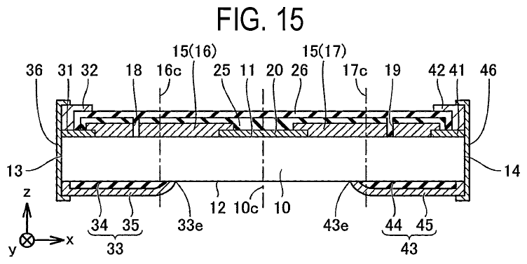

Referring to FIG. 15, a first side surface electrode 36 is formed over the first end surface 13 of the insulating substrate 10 by a sputtering method, and a second side surface electrode 46 is formed over the second end surface 14 of the insulating substrate 10 by a sputtering method.

Then, a first inner plating film 37 and a second inner plating film 47 (see FIG. 2) are formed by a plating method. The first inner plating film 37 is formed over the first auxiliary electrode 32, the first side surface electrode 36, and the first back surface electrode 33 (first conductive layer 35) to cover the first auxiliary electrode 32, the first side surface electrode 36, and the first back surface electrode 33 (first conductive layer 35). The second inner plating film 47 is formed over the second auxiliary electrode 42, the second side surface electrode 46, and the second back surface electrode 43 (second conductive layer 45) to cover the second auxiliary electrode 42, the second side surface electrode 46, and the second back surface electrode 43 (second conductive layer 45). The first inner plating film 37 and the second inner plating film 47 are, for example, nickel plating layers.

Then, a first outer plating film 38 and a second outer plating film 48 (see FIG. 2) are formed by a plating method. The first outer plating film 38 is formed over the first inner plating film 37 to cover the first inner plating film 37. The second outer plating film 48 is formed over the second inner plating film 47 to cover the second inner plating film 47. The first outer plating film 38 and the second outer plating film 48 are, for example, tin plating layers. In this way, the chip resistor 1 shown in FIGS. 1 to 3 is obtained.

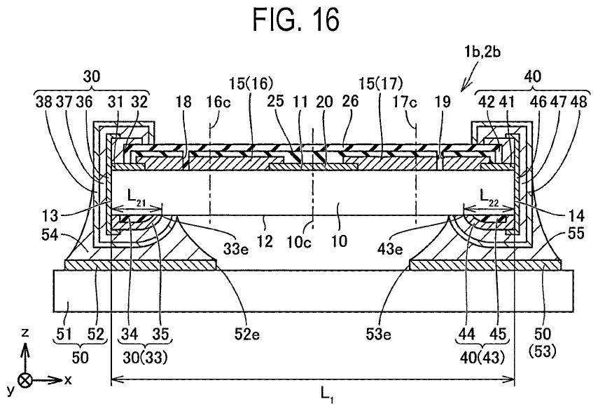

An operation of the chip resistor 1 of the present embodiment will be described while comparing the chip resistors 1 of Examples 1 to 4, which are specific examples of the present embodiment, with a chip resistor 1b of a comparative example. In the chip resistors 1 of Examples 1 to 4 and the chip resistor 1b of the comparative example, the length L₁ of the insulating substrate 10 in the longitudinal direction (first direction (x direction)) of the insulating substrate 10 is 6.4 mm. Referring to FIG. 16, the chip resistor 1b of the comparative example has a similar configuration to the chip resistors 1 of the present embodiment, but differs from the chip resistors 1 of the present embodiment in that each of the first length L₂₁ of the first back surface electrode 33 and the second length L₂₂ of the second back surface electrode 43 is less than 0.8 mm, and the area ratio of the back surface electrode to the back surface 12 of the insulating substrate 10 is less than 31%.

Specifically, as shown in Table 1, in the chip resistor 1b of the comparative example, each of the first length L₂₁ of the first back surface electrode 33 and the second length L₂₂ of the second back surface electrode 43 is 0.6 mm, and the area ratio of the back surface electrode to the back surface 12 of the insulating substrate 10 is 19%. In contrast, in the chip resistor 1 of Example 1, each of the first length L₂₁ of the first back surface electrode 33 and the second length L₂₂ of the second back surface electrode 43 is 0.8 mm, and the area ratio of the back surface electrode to the back surface 12 of the insulating substrate 10 is 31%. In the chip resistor 1 of Example 2, each of the first length L₂₁ of the first back surface electrode 33 and the second length L₂₂ of the second back surface electrode 43 is 1.0 mm, and the area ratio of the back surface electrode to the back surface 12 of the insulating substrate 10 is 38%. In the chip resistor 1 of Example 3, each of the first length L₂₁ of the first back surface electrode 33 and the second length L₂₂ of the second back surface electrode 43 is 1.2 mm, and the area ratio of the back surface electrode to the back surface 12 of the insulating substrate 10 is 44%. In the chip resistor 1 of Example 4, each of the first length L₂₁ of the first back surface electrode 33 and the second length L₂₂ of the second back surface electrode 43 is 1.4 mm, and the area ratio of the back surface electrode to the back surface 12 of the insulating substrate 10 is 53%.

TABLE 1

| | First length L₂₁ | Second length L₂₂ | Area ratio of | |
|---|---|---|---|---|
| | of first back | of second back | back surface | |
| | surface electrode | surface electrode | electrode | Vd/ |
| | 33 (mm) | 43 (mm) | (%) | Vr |
| Comparative | 0.6 | 0.6 | 19 | 2.2 |
| example | | | | |
| Example 1 | 0.8 | 0.8 | 31 | 2.3 |
| Example 2 | 1.0 | 1.0 | 38 | 2.6 |
| Example 3 | 1.2 | 1.2 | 44 | 2.6 |
| Example 4 | 1.4 | 1.4 | 53 | 2.95 |

Table 1 shows short time overload (STOL) characteristics of the chip resistors 1 of Examples 1 to 4 and the chip resistor 1b of the comparative example. The STOL characteristics of the chip resistors are expressed as a ratio (Vd/Vr) of the voltage Vd at which a rate of change in a resistance value of the chip resistor relative to a rated voltage Vr is 2%. As Vd/Vr becomes larger, the STOL characteristics of the chip resistor becomes higher. It can be seen from Table 1 that the chip resistors 1 of Examples 1 to 4 have improved STOL characteristics as compared to the chip resistor 1b of the comparative example.

Specifically, as the first length L₂₁ of the first back surface electrode 33 and the second length L₂₂ of the second back surface electrode 43 becomes longer, the STOL characteristics of the chip resistor 1 becomes more improved. The reason that the STOL characteristics of the chip resistor 1 are improved in this way is that as the first length L₂₁ of the first back surface electrode 33 and the second length L₂₂ of the second back surface electrode 43 become larger, the heat generated in the resistor layer 15 when a current flows through the chip resistor 1 is dissipated to an outside of the chip resistor 1 through the first back surface electrode 33 and the second back surface electrode 43 more efficiently. In addition, as the area ratio of the back surface electrode to the back surface 12 of the insulating substrate 10 is increased, the STOL characteristics of the chip resistor 1 improve. The reason that the STOL characteristics of the chip resistor 1 are improved in this way is that as the area ratio of the back surface electrode to the back surface 12 of the insulating substrate 10 becomes larger, the heat generated in the resistor layer 15 when a current flows through the chip resistor 1 is dissipated to the outside of the chip resistor 1 through the first back surface electrode 33 and the second back surface electrode 43 more efficiently.

The operation of the electronic circuit device 2 of the present embodiment will be described while comparing the electronic circuit devices 2 of Examples 1 to 4 with the electronic circuit device 2b of the comparative example. Referring to FIG. 16, the electronic circuit device 2b of the comparative example has a configuration similar to that of the electronic circuit device 2 of the present embodiment, but differs from the electronic circuit device 2 of the present embodiment in that the electronic circuit device 2b includes the chip resistor 1b of the comparative example described above instead of the chip resistor 1 of the present embodiment. Therefore, as shown in FIG. 16, in the electronic circuit device 2b of the comparative example, the end 33e of the first back surface electrode 33 is farther from the center 10c of the insulating substrate 10 than the end 52e of the land pattern 52 in the direction in which the first electrode 30 and the second electrode 40 are spaced apart from each other (first direction (x direction)). In the above-mentioned direction, the end 43e of the second back surface electrode 43 is farther from the center 10c of the insulating substrate 10 than the end 53e of the land pattern 53.

In contrast, the electronic circuit device 2 of Example 1 includes the chip resistor 1 of Example 1 already described. Therefore, as shown in FIG. 5, in the electronic circuit device 2 of Example 1, the end 33e of the first back surface electrode 33 is at the same position as the end 52e of the land pattern 52 in the direction in which the first electrode 30 and the second electrode 40 are spaced apart from each other (first direction (x direction)). In the above-mentioned direction, the end 43e of the second back surface electrode 43 is at the same position as the end 53e of the land pattern 53. That is, in the electronic circuit device 2 of Example 1, in the above-mentioned direction, the distance d₁ between the end 33e of the first back surface electrode 33 and the end 52e of the land pattern 52 is 0 mm, and the distance d₂ between the end 43e of the second back surface electrode 43 and the end 53e of the land pattern 53 is 0 mm.

The electronic circuit device 2 of Example 2 includes the chip resistor 1 of Example 2 already described. The electronic circuit device 2 of Example 3 includes the chip resistor 1 of Example 3 already described. The electronic circuit device 2 of Example 4 includes the chip resistor 1 of Example 4 already described. Therefore, as shown in FIG. 4, in the electronic circuit devices 2 of Examples 2 to 4, in the direction in which the first electrode 30 and the second electrode 40 are spaced apart from each other (first direction (x direction)), the end 33e of the first back surface electrode 33 is closer to the center 10c of the insulating substrate 10 than the end 52e of the land pattern 52, and the end 43e of the second back surface electrode 43 is closer to the center 10c of the insulating substrate 10 than the end 53e of the land pattern 53.

For example, in the electronic circuit device 2 of Example 2, in the direction in which the first electrode 30 and the second electrode 40 are spaced apart from each other (first direction (x direction)), the end 33e of the first back surface electrode 33 is closer to the center 10c of the insulating substrate 10 by a distance d₁ of 0.2 mm than the end 52e of the land pattern 52, and the end 43e of the second back surface electrode 43 is closer to the center 10c of the insulating substrate 10 by a distance d₂ of 0.2 mm than the end 53e of the land pattern 53. In the electronic circuit device 2 of Example 3, in the above-mentioned direction, the end 33e of the first back surface electrode 33 is closer to the center 10c of the insulating substrate 10 by a distance d₁ of 0.4 mm than the end 52e of the land pattern 52, and the end 43e of the second back surface electrode 43 is closer to the center 10c of the insulating substrate 10 by a distance d₂ of 0.4 mm than the end 53e of the land pattern 53. In the electronic circuit device 2 of Example 4, in the above-mentioned direction, the end 33e of the first back surface electrode 33 is closer to the center 10c of the insulating substrate 10 by a distance d₁ of 0.6 mm than the end 52e of the land pattern 52, and the end 43e of the second back surface electrode 43 is closer to the center 10c of the insulating substrate 10 by a distance d₂ of 0.6 mm than the end 53e of the land pattern 53.

Table 2 shows temperature cycle characteristics of the electronic circuit devices 2 of Examples 1 to 4 and temperature cycle characteristics of the electronic circuit device 2b of the comparative example. Temperature cycle tests are performed as follows. Thirty samples are prepared for each of the electronic circuit devices 2 of Examples 1 to 4 and the electronic circuit device 2b of the comparative example. A temperature cycle in which an ambient temperature of the sample is repeatedly changed between a low temperature of −55 degrees C. and a high temperature of +150 degrees C. is applied to the 30 samples. The number of repeated temperature cycles (the number of temperature cycles) and the number of samples in which the rate of change in resistance value between the land pattern 52 and the land pattern 53 via the chip resistor 1 exceeds 2% after the number of temperature cycles are recorded. In this way, the temperature cycle characteristics of the electronic circuit devices 2 of Examples 1 to 4 and the temperature cycle characteristics of the electronic circuit device 2b of the comparative example are obtained. As the number of samples in which the rate of change in resistance value between the land pattern 52 and the land pattern 53 via the chip resistor 1 exceeds 2% is decreased, the temperature cycle characteristics of the electronic circuit device becomes better. It can be seen from Table 2 that the electronic circuit devices 2 of Examples 1 to 4 have improved temperature cycle characteristics as compared to the electronic circuit device 2b of the comparative example.

TABLE 2

| | Number of temperature cycles | | | | |
|---|---|---|---|---|---|
| | 1,000 | 1,250 | 1,500 | 1,750 | 2,000 |
| Comparative | 0 | 1 | 3 | 3 | 4 |
| example | | | | | |
| Example 1 | 0 | 0 | 0 | 0 | 0 |
| Example 2 | 0 | 0 | 0 | 0 | 0 |
| Example 3 | 0 | 0 | 1 | 1 | 1 |
| Example 4 | 0 | 0 | 0 | 0 | 0 |

Specifically, when the first length L₂₁ of the first back surface electrode 33 is large and the end 33e of the first back surface electrode 33 is at the same position as the end 52e of the land pattern 52 or is closer to the center 10c of the insulating substrate 10 than the end 52e in the direction in which the first electrode 30 and the second electrode 40 are spaced apart from each other (first direction (x direction)), the temperature cycle characteristics of the electronic circuit device 2 are improved. When the second length L₂₂ of the second back surface electrode 43 is large and the end 43e of the second back surface electrode 43 is at the same position as the end 53e of the land pattern 53 or is closer to the center 10c of the insulating substrate 10 than the end 53e in the above-mentioned direction (first direction (x direction)), the temperature cycle characteristics of the electronic circuit device 2 are improved. The temperature cycle characteristics of the electronic circuit device 2 are improved as the area ratio of the back surface electrode to the back surface 12 of the insulating substrate 10 increases. The reasons that the temperature cycle characteristics of the electronic circuit device 2 are improved in this manner are as follows.

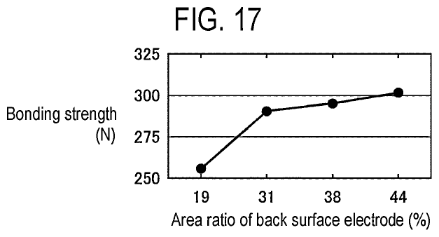

First, as the first length L₂₁ of the first back surface electrode 33 becomes larger, the second length L₂₂ of the second back surface electrode 43 becomes larger, or the area ratio of the back surface electrode to the back surface 12 of the insulating substrate 10 becomes larger, at least one of the contact area between the chip resistor 1 and the bonding member 54 or the contact area between the chip resistor 1 and the bonding member 55 becomes larger. As shown in FIG. 17, the bonding strength between the land patterns 52 and 53 and the back surface electrodes (the first back surface electrode 33 and the second back surface electrode 43) increases. Therefore, even in a case where the temperature cycle is applied to the electronic circuit device 2, occurrence of cracks in the bonding members 54 and 55 can be suppressed. The temperature cycle characteristics of the electronic circuit device 2 are improved.

Second, when a current flows through the chip resistor 1 and the temperature of the chip resistor 1 rises, the temperature of the insulating circuit board 51 also rises. In general, a thermal expansion coefficient of the insulating circuit board 51 is greater than that of the insulating substrate 10. Due to a difference between the thermal expansion coefficient of the insulating circuit board 51 and the thermal expansion coefficient of the insulating substrate 10, thermal stress is applied to the bonding members 54 and 55. The thermal stress is concentrated in a portion of the bonding member 54 near the end 33e of the first back surface electrode 33. The thermal stress is concentrated in a portion of the bonding member 55 near the end 43e of the second back surface electrode 43. Pulling force on the insulating substrate 10 by the insulating circuit board 51 decreases, as the insulating circuit board 51 approaches the center 10c of the insulating substrate 10. Therefore, as the end 33e of the first back surface electrode 33 approaches the center 10c of the insulating substrate 10, the thermal stress applied to the portion of the bonding member 54 near the end 33e of the first back surface electrode 33 decreases. As the end 43e of the second back surface electrode 43 approaches the center 10c of the insulating substrate 10, the thermal stress applied to the portion of the bonding member 55 near the end 43e of the second back surface electrode 43 decreases. As a result, even in a case where the temperature cycle is applied to the electronic circuit device 2, occurrence of cracks in the bonding members 54 and 55 can be suppressed. The temperature cycle characteristics of the electronic circuit device 2 are improved.

A computer aided engineering (CAE) analysis of thermal stress was performed on the electronic circuit device 2 of Example 3 and the electronic circuit device 2b of the comparative example. In the electronic circuit device 2b of the comparative example, the thermal stress applied to the portion of the bonding member 54 near the end 33e of the first back surface electrode 33 is 463.8 MPa. In contrast, in the electronic circuit device 2 of Example 3, the thermal stress applied to the portion of the bonding member 54 near the end 33e of the first back surface electrode 33 is reduced to 118.5 MPa. The present disclosers have found that cracks are more likely to occur in the bonding members 54 and 55 when the side surface electrodes (first side surface electrode 36 and second side surface electrode 46) of the chip resistor are formed by a sputtering method than when the side surface electrodes of the chip resistor are formed by a dip coating method. In the present embodiment, it is possible to prevent such cracks from occurring.

In a modification of the present embodiment, the resistor layer 15 does not have to be divided into the first resistor layer portion 16 and the second resistor layer portion 17, and may be a single resistor layer.

Effects of the chip resistor 1 and the electronic circuit device 2 according to the present embodiment will be described.

The chip resistor 1 of the present embodiment includes the insulating substrate 10, the resistor layer 15, the first electrode 30, and the second electrode 40. The insulating substrate 10 has the front surface 11, the back surface 12 on an opposite side of the insulating substrate 10 from the front surface 11, the first end surface 13 connected to the front surface 11 and the back surface 12, and the second end surface 14 on an opposite side of the insulating substrate 10 from the first end surface 13. The resistor layer 15 is disposed over the front surface 11 of the insulating substrate 10. The first electrode 30 is connected to the resistor layer 15. The second electrode 40 is connected to the resistor layer 15. The first end surface 13 and the second end surface 14 are spaced apart from each other in the direction in which the first electrode 30 and the second electrode 40 are spaced apart from each other. The first electrode 30 includes the first back surface electrode 33 disposed over the back surface 12 of the insulating substrate 10 and electrically connected to the resistor layer 15. The second electrode 40 includes the second back surface electrode 43 disposed over the back surface 12 of the insulating substrate 10 and electrically connected to the resistor layer 15. The ratio of the sum of the first area of the first back surface electrode 33 and the second area of the second back surface electrode 43 to the area of the back surface 12 of the insulating substrate 10 is 31% or more. Each of the first length L₂₁ of the first back surface electrode 33 in the above-mentioned direction and the second length L₂₂ of the second back surface electrode 43 in the above-mentioned direction is 0.8 mm or more.

Therefore, the heat generated in the resistor layer 15 when a current flows through the chip resistor 1 is more efficiently dissipated to the outside of the chip resistor 1 through the first back surface electrode 33 and the second back surface electrode 43. The STOL characteristics of the chip resistor 1 are improved.

Further, the chip resistor 1 increases the bonding strength between the chip resistor 1 and the circuit board 50 via the bonding members 54 and 55, and reduces the thermal stress applied to the bonding members 54 and 55 due to the difference between the thermal expansion coefficient of the chip resistor 1 and the thermal expansion coefficient of the circuit board 50. Therefore, it is possible to suppress the occurrence of cracks in the bonding members 54 and 55 interposed between the back surface electrodes (the first back surface electrode 33 and the second back surface electrode 43) of the chip resistor 1 and the circuit board 50.

In the chip resistor 1 of the present embodiment, the above-mentioned ratio is 38% or more.

Therefore, the heat generated in the resistor layer 15 when a current flows through the chip resistor 1 is more efficiently dissipated to the outside of the chip resistor 1 through the first back surface electrode 33 and the second back surface electrode 43. The STOL characteristics of the chip resistor 1 are improved. In addition, the chip resistor 1 can suppress the occurrence of cracks in the bonding members 54 and 55 interposed between the back surface electrodes (the first back surface electrode 33 and the second back surface electrode 43) of the chip resistor 1 and the circuit board 50.

In the chip resistor 1 of the present embodiment, each of the first length L₂₁ and the second length L₂₂ is 1.0 mm or more.

Therefore, the heat generated in the resistor layer 15 when a current flows through the chip resistor 1 is more efficiently dissipated to the outside of the chip resistor 1 through the first back surface electrode 33 and the second back surface electrode 43. The STOL characteristics of the chip resistor 1 are improved. In addition, the chip resistor 1 can suppress the occurrence of cracks in the bonding members 54 and 55 interposed between the back surface electrodes (the first back surface electrode 33 and the second back surface electrode 43) of the chip resistor 1 and the circuit board 50.

In the chip resistor 1 of the present embodiment, the trimming groove 18 is formed in the resistor layer 15. In a plan view of the front surface 11 of the insulating substrate 10, the first back surface electrode 33 overlaps with the trimming groove 18.

When a current flows through the chip resistor 1, the temperature particularly rises in the portion of the resistor layer 15 near the trimming groove 18. Because the first back surface electrode 33 overlaps with the trimming groove 18 in a plan view of the front surface 11 of the insulating substrate 10, the heat generated in the portion of the resistor layer 15 near the trimming groove 18 is dissipated from the first back surface electrode 33 to the outside of the chip resistor 1 via the insulating substrate 10. The STOL characteristics of the chip resistor 1 are improved.

The chip resistor 1 of the present embodiment further includes the intermediate electrode 20 disposed over the front surface 11 of the insulating substrate 10. The first electrode 30 includes the first front surface electrode 31 disposed over the front surface 11 of the insulating substrate 10. The second electrode 40 includes the second front surface electrode 41 disposed over the front surface 11 of the insulating substrate 10. The intermediate electrode 20 is disposed between the first front surface electrode 31 and the second front surface electrode 41. The resistor layer 15 includes the first resistor layer portion 16 connected to the first front surface electrode 31 and the intermediate electrode 20. In a plan view of the front surface 11 of the insulating substrate 10, the first back surface electrode 33 overlaps with the center 16c of the first resistor layer portion 16 in the direction in which the first electrode 30 and the second electrode 40 are spaced apart from each other.

When a current flows through the chip resistor 1, the temperature particularly rises at the center 16c of the first resistor layer portion 16. In a plan view of the front surface 11 of the insulating substrate 10, the first back surface electrode 33 overlaps with the center 16c of the first resistor layer portion 16. Therefore, the heat generated at the center 16c of the first resistor layer portion 16 is dissipated from the first back surface electrode 33 to the outside of the chip resistor 1 via the insulating substrate 10. The STOL characteristics of the chip resistor 1 are improved.

In the chip resistor 1 of the present embodiment, the resistor layer 15 includes the second resistor layer portion 17 connected to the second front surface electrode 41 and the intermediate electrode 20. In a plan view of the front surface 11 of the insulating substrate 10, the second back surface electrode 43 overlaps with the center 17c of the second resistor layer portion 17 in the direction in which the first electrode 30 and the second electrode 40 are spaced apart from each other (the first direction (x direction)).

When a current flows through the chip resistor 1, the temperature particularly rises at the center 17c of the second resistor layer portion 17. In a plan view of the front surface 11 of the insulating substrate 10, the second back surface electrode 43 overlaps with the center 17c of the second resistor layer portion 17. Therefore, the heat generated at the center 17c of the second resistor layer portion 17 is dissipated from the second back surface electrode 43 to the outside of the chip resistor 1 via the insulating substrate 10. The STOL characteristics of the chip resistor 1 are improved.

The electronic circuit device 2 of the present embodiment includes the chip resistor 1 of the present embodiment, the circuit board 50, the first bonding member (bonding member 54), and the second bonding member (bonding member 55). The circuit board 50 includes the first land pattern (land pattern 52) and the second land pattern (land pattern 53) spaced apart from the first land pattern. The first back surface electrode 33 is bonded to the first land pattern by using the first bonding member. The second back surface electrode 43 is bonded to the second land pattern by using the second bonding member. In the direction in which the first electrode 30 and the second electrode 40 are spaced apart from each other (first direction (x direction)), the first end (end 33e) of the first back surface electrode 33 adjacent to the center 10c of the insulating substrate 10 is at the same position as the second end (end 52e) of the first land pattern adjacent to the center 10c of the insulating substrate 10, or is closer to the center 10c of the insulating substrate 10 than the second end.

Therefore, a contact area between the chip resistor 1 and the first bonding member (bonding member 54) is increased to improve the bonding strength between the chip resistor 1 and the circuit board 50 via the first bonding member. In addition, the thermal stress applied to the first bonding member due to the difference between the thermal expansion coefficient of the chip resistor 1 and the thermal expansion coefficient of the circuit board 50 is decreased. Even in a case where the temperature cycle is applied to the electronic circuit device 2, the occurrence of cracks in the first bonding member can be suppressed. The temperature cycle characteristics of the electronic circuit device 2 are improved. In addition, since the electronic circuit device 2 of the present embodiment includes the chip resistor 1, the electronic circuit device 2 has improved STOL characteristics and higher reliability.

In the electronic circuit device 2 of the present embodiment, the length L₁ of the insulating substrate 10 from the first end surface 13 to the second end surface 14 is greater than 3.2 mm.

When the length L₁ of the insulating substrate 10 from the first end surface 13 to the second end surface 14 increases, the thermal stress applied to the first bonding member (bonding member 54) is increased due to the difference between the thermal expansion coefficient of the chip resistor 1 and the thermal expansion coefficient of the circuit board 50. However, in the electronic circuit device 2 of the present embodiment, the first end (end 33e) of the first back surface electrode 33 is at the same position as the second end (end 52e) of the first land pattern (land pattern 52), or is closer to the center 10c of the insulating substrate 10 than the second end. Therefore, the thermal stress applied to the first bonding member is decreased due to the difference between the thermal expansion coefficient of the chip resistor 1 and the thermal expansion coefficient of the circuit board 50. Even in a case where the temperature cycle is applied to the electronic circuit device 2, the occurrence of cracks in the first bonding member can be suppressed. The temperature cycle characteristics of the electronic circuit device 2 are improved.

In the electronic circuit device 2 of the present embodiment, each of the first back surface electrode 33 and the second back surface electrode 43 includes the insulating resin layer (the first insulating resin layer 34 and the second insulating resin layer 44) disposed over the back surface 12 of the insulating substrate 10, and the conductive layer (the first conductive layer 35 and the second conductive layer 45) disposed over the insulating resin layer. The conductive layer is made of a conductive material containing a binder resin and metal particles distributed in the binder resin.

The insulating resin layer (the first insulating resin layer 34 and the second insulating resin layer 44) improves the bonding strength of the first back surface electrode 33 and the second back surface electrode 43 to the insulating substrate 10. The conductive layer (the first conductive layer 35 and the second conductive layer 45) of the present embodiment has a lower Young's modulus than a conductive layer made of a conductive material containing glass and metal particles. Therefore, the thermal stress applied to the first bonding member (bonding member 54) and the second bonding member (bonding member 55) is decreased due to the difference between the thermal expansion coefficient of the chip resistor 1 and the thermal expansion coefficient of the circuit board 50. Even in a case where the temperature cycle is applied to the electronic circuit device 2, the occurrence of cracks in the first bonding member and the second bonding member can be suppressed. The temperature cycle characteristics of the electronic circuit device 2 are improved.

In the electronic circuit device 2 of the present embodiment, in the direction in which the first electrode 30 and the second electrode 40 are spaced apart from each other (first direction (x direction)), the first end (end 33e) of the first back surface electrode 33 is closer to the center 10c of the insulating substrate 10 by 0.2 mm or more than the second end (end 52e) of the first land pattern (land pattern 52).

Therefore, the contact area between the chip resistor 1 and the first bonding member (bonding member 54) is increased, and the bonding strength between the chip resistor 1 and the circuit board 50 via the first bonding member is improved. Further, the thermal stress applied to the first bonding member is decreased due to the difference between the thermal expansion coefficient of the chip resistor 1 and the thermal expansion coefficient of the circuit board 50. Even in a case where the temperature cycle is applied to the electronic circuit device 2, the occurrence of cracks in the first bonding member can be suppressed. The temperature cycle characteristics of the electronic circuit device 2 are improved.

In the electronic circuit device 2 of the present embodiment, in the direction in which the first electrode 30 and the second electrode 40 are spaced apart from each other (the first direction (x direction)), the third end (end 43e) of the second back surface electrode 43 adjacent to the center 10c of the insulating substrate 10 is at the same position as the fourth end (end 53e) of the second land pattern (land pattern 53) adjacent to the center 10c of the insulating substrate 10, or is closer to the center 10c of the insulating substrate 10 than the fourth end.

Therefore, the contact area between the chip resistor 1 and the second bonding member (bonding member 55) is increased, and the bonding strength between the chip resistor 1 and the circuit board 50 via the second bonding member is improved. Further, the thermal stress applied to the second bonding member is decreased due to the difference between the thermal expansion coefficient of the chip resistor 1 and the thermal expansion coefficient of the circuit board 50. Even in a case where the temperature cycle is applied to the electronic circuit device 2, the occurrence of cracks in the second bonding member can be suppressed. The temperature cycle characteristics of the electronic circuit device 2 are improved.

In the electronic circuit device 2 of the present embodiment, in the direction in which the first electrode 30 and the second electrode 40 are spaced apart from each other (the first direction (x direction)), the third end (end 43e) of the second back surface electrode 43 is closer to the center 10c of the insulating substrate 10 by 0.2 mm or more than the fourth end (end 53e) of the second land pattern (land pattern 53).

Therefore, the contact area between the chip resistor 1 and the second bonding member (bonding member 55) is increased, and the bonding strength between the chip resistor 1 and the circuit board 50 via the second bonding member is improved. Further, the thermal stress applied to the second bonding member is decreased due to the difference between the thermal expansion coefficient of the chip resistor 1 and the thermal expansion coefficient of the circuit board 50. Even in a case where the temperature cycle is applied to the electronic circuit device 2, the occurrence of cracks in the second bonding member can be suppressed. The temperature cycle characteristics of the electronic circuit device 2 are improved.

Various aspects of the present disclosure are summarized below as supplementary notes.

### (Supplementary Note 1)

A chip resistor including:
an insulating substrate having a front surface, a back surface on an opposite side of the insulating substrate from the front surface, a first end surface connected to the front surface and the back surface, and a second end surface on an opposite side of the insulating substrate from the first end surface;
a resistor layer disposed over the front surface;
a first electrode connected to the resistor layer; and
a second electrode connected to the resistor layer,
wherein the first end surface and the second end surface are spaced apart from each other in a direction in which the first electrode and the second electrode are spaced apart from each other,
wherein the first electrode includes a first back surface electrode disposed over the back surface and electrically connected to the resistor layer,
wherein the second electrode includes a second back surface electrode disposed over the back surface and electrically connected to the resistor layer,
wherein a ratio of a sum of a first area of the first back surface electrode and a second area of the second back surface electrode to an area of the back surface is 31% or more, and
wherein each of a first length of the first back surface electrode in the direction and a second length of the second back surface electrode in the direction is 0.8 mm or more.

### (Supplementary Note 2)

The chip resistor of Supplementary Note 1, wherein the ratio is 38% or more.

### (Supplementary Note 3)

The chip resistor of Supplementary Note 1 or 2, wherein each of the first length and the second length is 1.0 mm or more.

### (Supplementary Note 4)

The chip resistor of any one of Supplementary Notes 1 to 3, wherein a trimming groove is formed in the resistor layer, and
wherein the first back surface electrode overlaps with the trimming groove in a plan view of the front surface.

### (Supplementary Note 5)

The chip resistor of any one of Supplementary Notes 1 to 4, further including an intermediate electrode disposed over the front surface,
wherein the first electrode includes a first front surface electrode arranged over the front surface,
wherein the second electrode includes a second front surface electrode arranged over the front surface,
wherein the intermediate electrode is arranged between the first front surface electrode and the second front surface electrode,
wherein the resistor layer includes a first resistor layer portion connected to the first front surface electrode and the intermediate electrode, and
wherein the first back surface electrode overlaps with a center of the first resistor layer portion in the direction in a plan view of the front surface.

### (Supplementary Note 6)

The chip resistor of Supplementary Note 5, wherein the resistor layer includes a second resistor layer portion connected to the second front surface electrode and the intermediate electrode, and
wherein the second back surface electrode overlaps with a center of the second resistor layer portion in the direction in the plan view of the front surface.

### (Supplementary Note 7)

An electronic circuit device, including:
the chip resistor of any one of Supplementary Notes 1 to 6;
a circuit board including a first land pattern and a second land pattern spaced apart from the first land pattern;
a first bonding member; and
a second bonding member,
wherein the first back surface electrode is bonded to the first land pattern by using the first bonding member,
wherein the second back surface electrode is bonded to the second land pattern by using the second bonding member, and
wherein in the direction, a first end of the first back surface electrode adjacent to a center of the insulating substrate is at the same position as a second end of the first land pattern adjacent to the center of the insulating substrate or is closer to the center of the insulating substrate than the second end.

### (Supplementary Note 8)

The electronic circuit device of Supplementary Note 7, wherein a length of the insulating substrate from the first end surface to the second end surface is greater than 3.2 mm.

### (Supplementary Note 9)

The electronic circuit device of Supplementary Note 7 or 8, wherein each of the first back surface electrode and the second back surface electrode includes an insulating resin layer disposed over the back surface and a conductive layer disposed over the insulating resin layer, and
wherein the conductive layer is made of a conductive material containing a binder resin and metal particles distributed in the binder resin.

### (Supplementary Note 10)

The electronic circuit device of any one of Supplementary Notes 7 to 9, wherein in the direction, the first end is closer to the center of the insulating substrate by 0.2 mm or more than the second end.

### (Supplementary Note 11)

The electronic circuit device of any one of Supplementary Notes 7 to 10, wherein in the direction, a third end of the second back surface electrode adjacent to the center of the insulating substrate is at the same position as a fourth end of the second land pattern adjacent to the center of the insulating substrate, or is closer to the center of the insulating substrate than the fourth end.

### (Supplementary Note 12)

The electronic circuit device of Supplementary Note 11, wherein in the direction, the third end is closer to the center of the insulating substrate by 0.2 mm or more than the fourth end.

The embodiments disclosed herein should be considered to be exemplary and not restrictive in all respects. The scope of the present disclosure is defined by the claims, not the above description, and is intended to include all modifications within the meaning and scope of the claims.

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A chip resistor comprising:
an insulating substrate having a front surface, a back surface on an opposite side of the insulating substrate from the front surface, a first end surface connected to the front surface and the back surface, and a second end surface on an opposite side of the insulating substrate from the first end surface;
a resistor layer disposed over the front surface;
a first electrode connected to the resistor layer; and
a second electrode connected to the resistor layer,
wherein the first end surface and the second end surface are spaced apart from each other in a direction in which the first electrode and the second electrode are spaced apart from each other,
wherein the first electrode includes a first back surface electrode disposed over the back surface and electrically connected to the resistor layer,
wherein the second electrode includes a second back surface electrode disposed over the back surface and electrically connected to the resistor layer,
wherein a ratio of a sum of a first area of the first back surface electrode and a second area of the second back surface electrode to an area of the back surface is 31% or more, and
wherein each of a first length of the first back surface electrode in the direction and a second length of the second back surface electrode in the direction is 0.8 mm or more.

2. The chip resistor of claim 1, wherein the ratio is 38% or more.

3. The chip resistor of claim 1, wherein each of the first length and the second length is 1.0 mm or more.

4. The chip resistor of claim 1, wherein a trimming groove is formed in the resistor layer, and
wherein the first back surface electrode overlaps with the trimming groove in a plan view of the front surface.

5. The chip resistor of claim 1, further comprising an intermediate electrode disposed over the front surface,
wherein the first electrode includes a first front surface electrode arranged over the front surface,
wherein the second electrode includes a second front surface electrode arranged over the front surface,
wherein the intermediate electrode is arranged between the first front surface electrode and the second front surface electrode,
wherein the resistor layer includes a first resistor layer portion connected to the first front surface electrode and the intermediate electrode, and
wherein the first back surface electrode overlaps with a center of the first resistor layer portion in the direction in a plan view of the front surface.

6. The chip resistor of claim 5, wherein the resistor layer includes a second resistor layer portion connected to the second front surface electrode and the intermediate electrode, and
wherein the second back surface electrode overlaps with a center of the second resistor layer portion in the direction in the plan view of the front surface.

7. An electronic circuit device, comprising:
the chip resistor of claim 1;
a circuit board including a first land pattern and a second land pattern spaced apart from the first land pattern;
a first bonding member; and
a second bonding member,
wherein the first back surface electrode is bonded to the first land pattern by using the first bonding member,
wherein the second back surface electrode is bonded to the second land pattern by using the second bonding member, and
wherein in the direction, a first end of the first back surface electrode adjacent to a center of the insulating substrate is at the same position as a second end of the first land pattern adjacent to the center of the insulating substrate or is closer to the center of the insulating substrate than the second end.

8. The electronic circuit device of claim 7, wherein a length of the insulating substrate from the first end surface to the second end surface is greater than 3.2 mm.

9. The electronic circuit device of claim 7, wherein each of the first back surface electrode and the second back surface electrode includes an insulating resin layer disposed over the back surface and a conductive layer disposed over the insulating resin layer, and
wherein the conductive layer is made of a conductive material containing a binder resin and metal particles distributed in the binder resin.

10. The electronic circuit device of claim 7, wherein in the direction, the first end is closer to the center of the insulating substrate by 0.2 mm or more than the second end.

11. The electronic circuit device of claim 7, wherein in the direction, a third end of the second back surface electrode adjacent to the center of the insulating substrate is at the same position as a fourth end of the second land pattern adjacent to the center of the insulating substrate or is closer to the center of the insulating substrate than the fourth end.

12. The electronic circuit device of claim 11, wherein in the direction, the third end is closer to the center of the insulating substrate by 0.2 mm or more than the fourth end.
